(19) United States
(12) Patent Application Publication
(10) Pub. No.: US 2012/0137093 A1
(43) Pub. Date: May 31, 2012

(54) RELIABLE WRITE FOR NON-VOLATILE MEMORY

(75) Inventors: Marco Ferrario, Milano (MI) (IT); Emanuele Confalonieri, Lesmo (Milano) (IT); Danilo Caraccio, Buonalbergo (Benevento) (IT)

(73) Assignee: Micron Technology, Inc., Boise, ID (US)

(21) Appl. No.: 12/956,742

(22) Filed: Nov. 30, 2010

(51) Int. Cl. G06F 12/16; G06F 12/00

(52) U.S. Cl. 711/162; 711/E12.001; 711/E12.103

(57) ABSTRACT

Example embodiments described herein may relate to performing reliable right commands for non-volatile memory devices.

### BACKGROUND

Subject matter disclosed herein may relate to non-volatile memory devices, and may relate more particularly to write operations for non-volatile memory devices.

Non-volatile memory devices may be found in a wide range of electronic devices. In particular, non-volatile memory devices may be used in computers, digital cameras, cellular telephones, personal digital assistants, etc. Non-volatile memory devices may comprise a controller to manage access operations to an array of non-volatile memory cells. For example, to manage a write access operation to a memory array, a non-volatile memory device controller may receive a write command and may also receive write data from an input/output interface, and may further manage access to the memory array. For a system wherein a processor may initiate a write command to a non-volatile memory by transmitting the write command and data to the non-volatile memory, once the processor transmits the write command and data to the non-volatile memory, that may generally be the end of the processor's involvement with the write process, as the write command may be completed within the non-volatile memory device with help from its internal controller. If a power event occurs while the internal controller is performing the write operation, an indeterminate state may exist for those memory locations being programmed.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is a schematic block diagram illustrating an example embodiment of a computing platform.

FIG. 2 is a schematic block diagram depicting an example embodiment of a non-volatile memory device.

FIG. 3 is a schematic block diagram depicting an example embodiment of data backup registers.

FIG. 4 is a block diagram illustrating example states of example storage areas within an example embodiment of a non-volatile memory device during an example aspect of an example memory program operation.

FIG. 5 is a block diagram depicting further example states of example storage areas within an example embodiment of a non-volatile memory device during an example aspect of an example memory program operation.

FIG. 6 is a block diagram illustrating example states of example storage areas within an example embodiment of a non-volatile memory device during an example aspect of an example memory program operation.

FIG. 7 is a block diagram illustrating example states of example storage areas within an example embodiment of a non-volatile memory device during an example aspect of an example memory program operation.

FIG. 8 is a block diagram depicting example states of example storage areas within an example embodiment of a non-volatile memory device during an example aspect of an example memory program operation.

FIG. 9 is a block diagram illustrating example states of example storage areas within an example embodiment of a non-volatile memory device during an example aspect of an example memory program operation.

FIG. 10 is a flow diagram depicting an example embodiment of a process for reliable write operation for an example embodiment of a non-volatile memory.

Reference is made in the following detailed description to the accompanying drawings, which form a part hereof, wherein like numerals may designate like parts throughout to indicate corresponding or analogous elements. It will be appreciated that for simplicity and/or clarity of illustration, elements illustrated in the figures have not necessarily been drawn to scale. For example, the dimensions of some of the elements may be exaggerated relative to other elements for clarity. Further, it is to be understood that other embodiments may be utilized. Furthermore, structural or logical changes may be made without departing from the scope of claimed subject matter. It should also be noted that directions or references, for example, up, down, top, bottom, and so on, may be used to facilitate discussion of the drawings and are not intended to restrict the application of claimed subject matter. Therefore, the following detailed description is not to be taken to limit the scope of claimed subject matter or their equivalents.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

As mentioned above, non-volatile memory devices may be found in a wide range of electronic devices. In particular, non-volatile memory devices may be used in computers, digital cameras, cellular telephones, personal digital assistants, etc. Non-volatile memory devices may comprise a controller to manage access operations to an array of non-volatile memory cells. For example, to manage a write access operation to a memory array, a non-volatile memory device controller may receive a write command and may also receive write data from an input/output interface, and may further manage access to the memory array. For a system wherein a processor may initiate a write command to a non-volatile memory by transmitting the write command and data to the non-volatile memory, once the processor transmits the write command and data to the non-volatile memory, that may generally be the end of the processor's involvement with the write process, as the write command may be completed within the non-volatile memory device with help from its internal controller. If a power event occurs while the internal controller is performing the write operation, an indeterminate state may exist for those memory locations being programmed.

Example embodiments described herein may provide techniques for determining a state of a write operation if a power event occurs during the execution of the write command. As used herein, the term “power event” refers to any situation resulting in a reduction or loss of power to a memory device or to a system as a whole. In an example embodiment, a separate storage register for write data may be provided. As used herein, the term “data” refers to any type of information that may be transmitted using a write operation. Such data may include executable instructions, for example, although the scope of claimed subject matter is not limited in this respect.

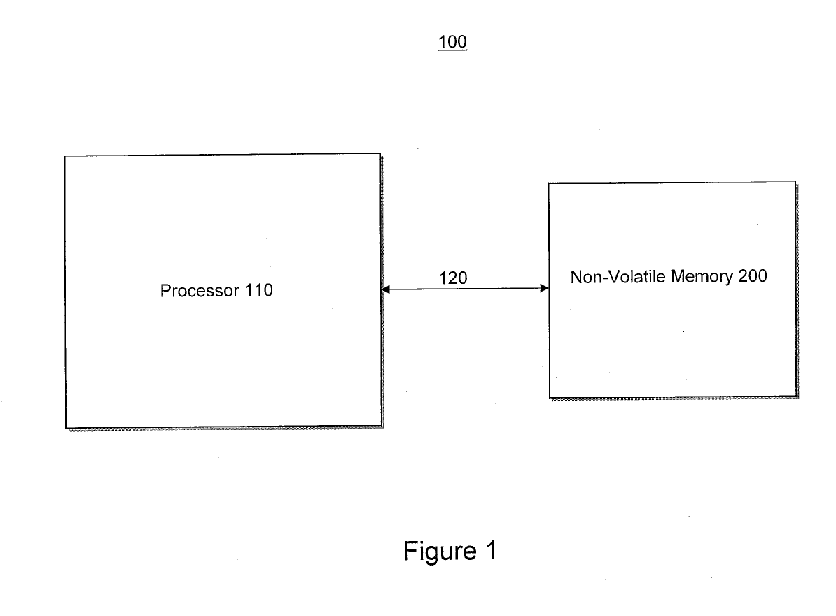

FIG. 1 is a block diagram of an example embodiment of a computing platform 100, comprising a processor 110 and a non-volatile memory 200. For the present example, non-volatile memory device 200 comprises a PCM memory device, although the scope of claimed subject matter is not limited in this respect. For example, embodiments of non-volatile memory in accordance with claimed subject matter may comprise NAND or NOR flash memory, although again, the scope of claimed subject matter is not limited in this respect. Memory 200 for this example may be coupled to processor 110 by way of a parallel interconnect 120, although again, the scope of claimed subject matter is not limited in this respect. For example, other embodiments may comprise a serial interconnect. Also for an embodiment, processor 110 may fetch instructions stored in an array of non-volatile memory cells in memory 200, and processor 110 may execute the fetched instructions. Data may also be written to one or more non-volatile memory cells of an array of non-volatile memory cells by processor 110, wherein a write operation may be initiated by processor 110 and completed internally within memory 200. A controller within non-volatile memory 200 may be utilized to implement read or write accesses to a non-volatile memory array, in accordance with one or more command codes received from processor 110.

The term “computing platform” as used herein refers to a system or a device that includes the ability to process or store data in the form of signals. Thus, a computing platform, in this context, may comprise hardware, software, firmware or any combination thereof. Computing platform 100, as depicted in FIG. 1, is merely one such example, and the scope of claimed subject matter is not limited in these respects. For one or more embodiments, a computing platform may comprise any of a wide range of digital electronic devices, including, but not limited to, personal desktop or notebook computers, high-definition televisions, digital versatile disc (DVD) players or recorders, game consoles, satellite television receivers, cellular telephones, personal digital assistants, mobile audio or video playback or recording devices, and so on. Further, unless specifically stated otherwise, a process as described herein, with reference to flow diagrams or otherwise, may also be executed or controlled, in whole or in part, by a computing platform.

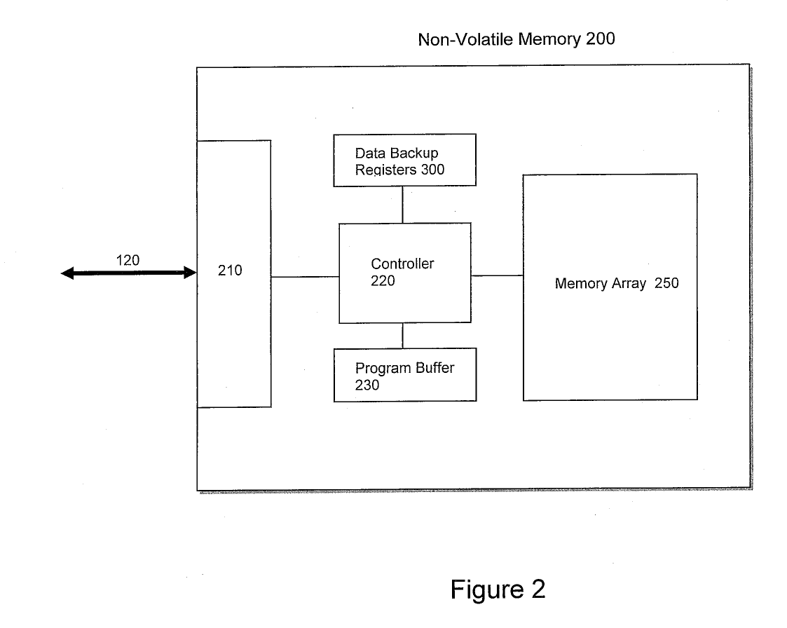

FIG. 2 is a schematic block diagram depicting an example embodiment of non-volatile memory device 200 including an interconnect interface 210 to receive one or more control signals or command codes from processor 110, for an example. For one or more embodiments, a controller 220 may receive the one or more control signals or command codes from processor 110 via interconnect 120 and interface 210, and may generate one or more internal control signals to perform any of a number of operations, including data read and/or write operations, by which processor 110 may access non-volatile memory array 250, for example. As used herein, the term “controller” is meant to include any circuitry or logic involved in the management and/or execution of command sequences as they relate to non-volatile memory devices. The term “controller” further refers to an ability to execute firmware instructions as part of the management and/or execution of command sequences.

Non-volatile memory 200 for this example embodiment may further comprise a program buffer 230 that may be utilized to temporarily store information to be written to a location in memory array 250. In an embodiment, program buffer 230 may have a capacity of 512 Bytes, although embodiments in accordance with claimed subject matter are not limited in this respect. Further, in an embodiment, program buffer 230 may comprise a volatile storage area. Also, in an embodiment, non-volatile memory 200 may comprise data backup registers 300, discussed in more detail, below. In an embodiment, data backup registers 300 may comprise non-volatile memory. In general, non-volatile data backup registers 300 may be utilized to store address, data, or control information that may be utilized to guard against situations involving power events wherein an in-progress memory write operation may result in an indeterminate state for the data in the process of being written to memory array 250. Example embodiments are described in more detail, below.

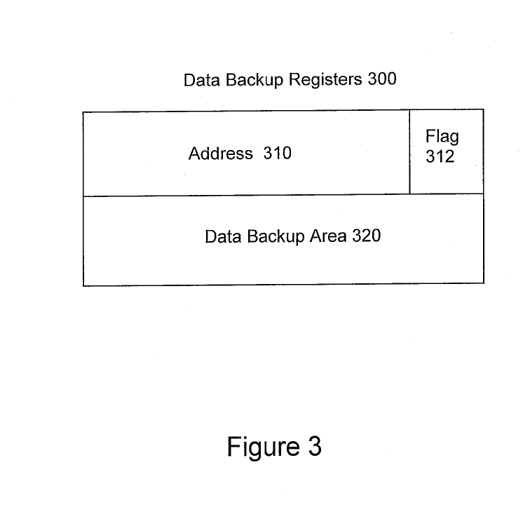

FIG. 3 is a schematic block diagram depicting an example embodiment of non-volatile data backup registers 300. Data backup registers 300 may be utilized, in an embodiment, to store address, data, or control information that may be utilized to guard against indeterminate states for data in the process of being written to non-volatile memory when interrupted by a power event. Data backup registers 300 may be implemented using flash or PCM memory technologies, in one or more example embodiments. Also, in an embodiment, data backup registers 300 may comprise an address field 310 to store an address that points to a location within non-volatile memory array 250 that is a target of a current memory write operation. Also in an embodiment, data backup registers 300 further comprises a flag field 312, and a data backup area 320. Data backup area 320 may be utilized, in an embodiment, to temporarily store a cope of data to be written or having been written to a location within memory array 250. Possible uses for example embodiments of address field 310, flag field 312, and data backup area 320 of data backup registers 300 are described below.

In an embodiment of a system such as computing platform 100, example commands that may be utilized to modify a content of a non-volatile memory array such as array 250 may include a Buffered Program command or a Buffered Overwrite command. Such commands may be utilized for non-volatile memory types such as, for example, NOR flash, NAND flash, or phase change memory (PCM) memory devices. Such example commands may utilize internal buffers to store data to be written to a memory location with an array prior to commencing a buffered overwrite or buffered program command. An example buffered program command may modify individual bits of a memory array by turning the bits from a binary value of ‘1’ to a binary value of ‘0’. Memory devices based on flash or PCM technologies may take advantage of buffered program commands. A buffered overwrite command, on the other hand, may program binary values of both ‘0’ and ‘1’. Memory devices based on PCM technologies may support buffered overwrite commands, in one or more example embodiments.

In one or more embodiments, a “reliable write” mode of operation may be made available for use with buffered program or buffered overwrite commands. As used herein, the term “reliable write” refers to any technique or process that may reduce a likelihood of an indeterminate state existing for one or more memory locations targeted by a program or write command. As previously mentioned, indeterminate states for memory locations targeted by write operations may result from power events, in some situations. However, the term “reliable write” and associated embodiments are not limited to use in connection with power events, but rather may further be used for any event that may interrupt a write or program operation. In one or more embodiments utilizing an example reliable write mode of operation, memory locations within an array targeted by interrupted write operations may be visible to system resources external to the memory device as either unchanged as if the interrupted write operation never took place or updated with new data as if the write operation had completed without interruption.

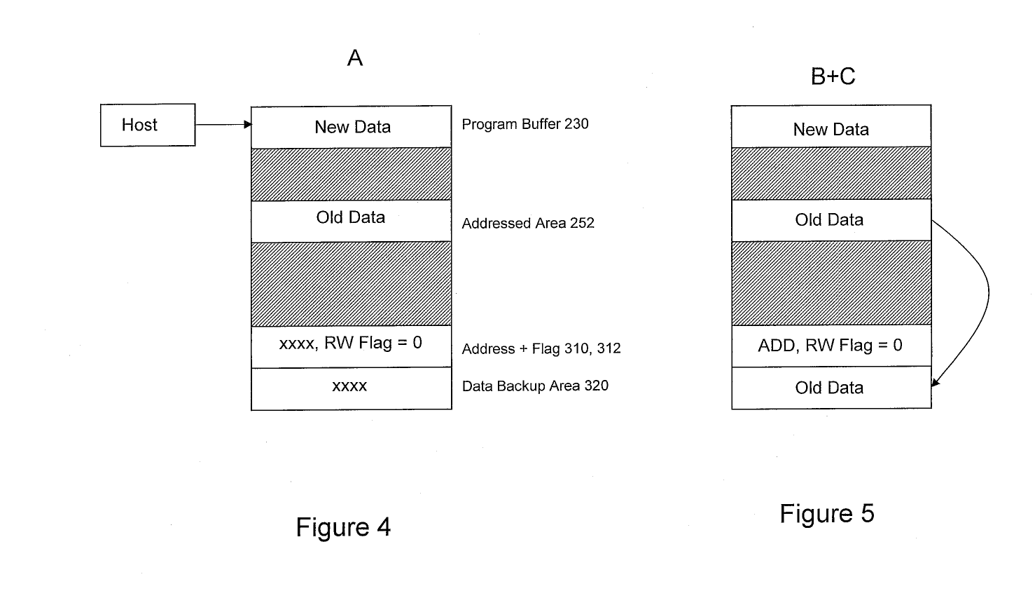

FIGS. 4-9 illustrate example elements of an example technique for providing a reliable write mode of operation. As depicted at FIG. 4, for an example element “A” of the present example, incoming data, referred to as “new data”, meant to be programmed into a targeted location within a memory array such as array 250, may be loaded into program buffer 230. As also depicted in FIG. 4, an addressed area within array 250 currently has stored therein what may be referred to as “old data” for the purposes of the present example. Also for the present example, flag field 312 is currently not set.

As depicted in FIG. 5 for an example element “B” of the example technique, the old data may be copied into data backup area 320. As further depicted in FIG. 5, for an example element “C” of the example technique, one or more command arguments, such as, for example, a start address specifying at least in part one or more targeted memory array locations, may be stored in address field 310.

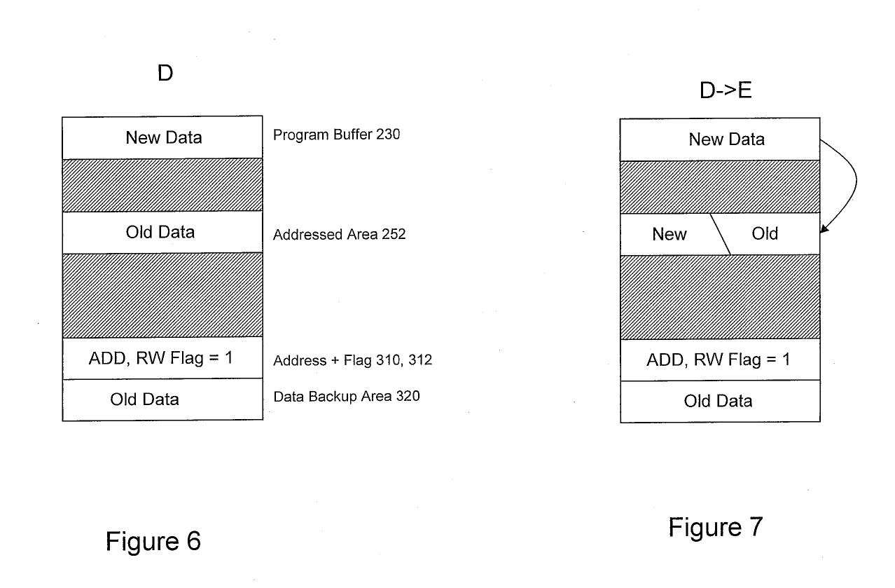

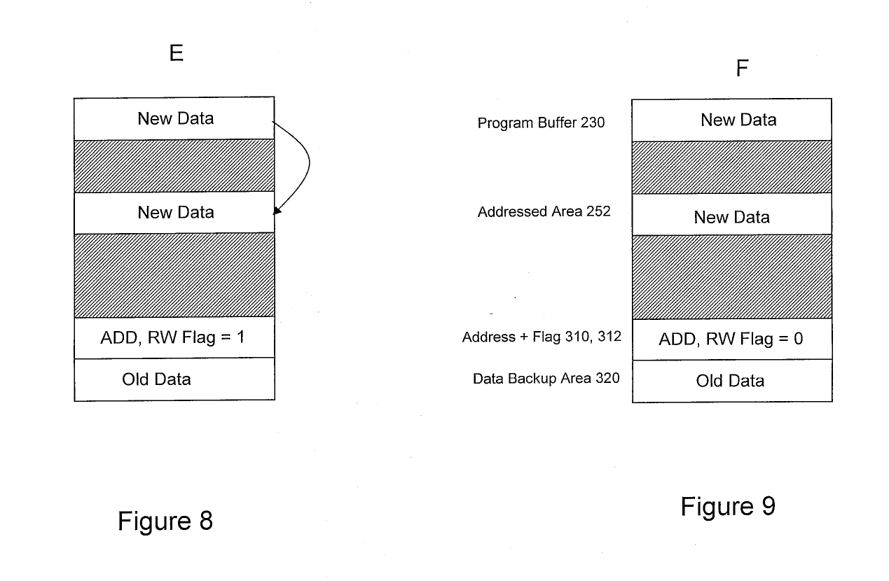

Further, as illustrated in FIG. 6, for an example element “D” of the example technique, a reliable write (RW) flag stored in flag field 312 may be set to a binary value of ‘1’ to indicate that a reliable write operation is in process. Additionally, as depicted in FIG. 8, for an example element “E” of the example technique, the new data may be moved from program buffer 230 to addressed area 252 in the non-volatile memory array. As depicted in FIG. 9, for an example element “F” of the example technique, the RW flag in flag field 312 may be reset to indicate that the reliable write operation has completed.

FIG. 7 illustrates a transition between example elements D and E of an embodiment. As can be seen at addressed area 252 within the memory array, some bits of area 250 contain old data and some bits contain new data. This provides an illustration of a situation whereby states of a number of bits within a non-volatile array of memory may be indeterminate in the event of an interruption of a program command. Without a reliable write mode of operation, if a power event occurs while addressed area 252 is updating, no recovery of lost or damaged data would be possible because the states of the various bits within a targeted location within a memory array would be unknown.

In one or more embodiments, a power event may occur at any point during a program command. After a power loss, for an embodiment, a power-loss recovery routine may be performed to return a memory to a known state. For an embodiment, upon power up of a system incorporating non-volatile memory with reliable write support, such as system 100 depicted in FIG. 1, a check may be made of RW flag in field 312 to determine whether a reliable write operation was in process at the time of loss of power. The check of the flag may be referred to herein as example element ‘a’ of an example power-loss recovery technique. For an example element ‘b’ of an example power-loss recovery technique, if the RW flag is discovered to be set, old data may be copied from data backup area 320 to addressed area 252. An example element ‘c’ may include resetting the RW flag.

The following table includes information regarding possible power-loss recovery actions that may be taken to return a memory to a known state, for one or more example embodiments. Specific actions to be taken may depend, at least in part, on at which element of a reliable write operation the power event occurs. Note that power events may also occur during power-loss recovery operations, and those situations are also covered by example embodiments described herein.

TABLE 1
Power-Loss Recovery for Reliable Write

| | Content of | Content of | |
|---|---|---|---|
| Element | addressed area | addressed | |
| during | 252 in memory | area 252 in | |
| which | array 250 prior | memory array | |
| power | to power-up | 250 after | |
| event | following | power-loss | Power-loss recovery |
| occurred | power-event | operations | operations performed |
| A, B, C | Old Data | Old Data | RW Flag = 0 −> no |
| | | | operation |
| D | Old Data | Old Data | 1) Copy content of data |
| | | | backup area to addressed |
| | | | area of memory array; 2) |
| | | | Reset RW Flag |
| D−>E | Undetermined | Old Data | 1) Copy content of data |
| | | | backup area to addressed |
| | | | area of memory array; 2) |
| | | | Reset RW Flag |
| E | New Data | Old Data | 1) Copy content of data |
| | | | backup area to addressed |
| | | | area of memory array; 2) |
| | | | Reset RW Flag |
| F | New Data | New Data | RW Flag = 0 −> no |
| | | | operation |
| a, b | Undetermined | Old Data | 1) Copy content of data |
| | | | backup area to addressed |
| | | | area of memory array; 2) |
| | | | Reset RW Flag |
| c | Old Data | Old Data | RW Flag = 0 −> no |
| | | | operation |

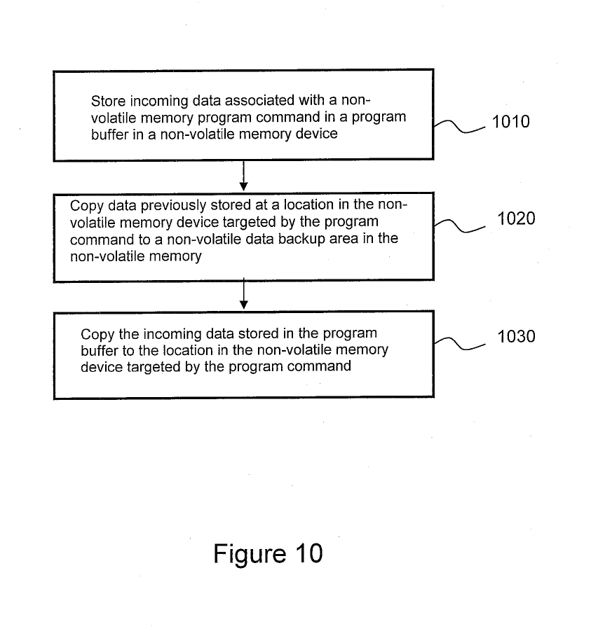

FIG. 10 is a flow diagram depicting an example embodiment of a method for reliable write operation. At block 1010, incoming data associated with a non-volatile memory program command may be stored in a program buffer in a non-volatile memory device. At block 1020, data previously stored at a location in the non-volatile memory device targeted by the program command may be copied to a non-volatile data backup area in the non-volatile memory. The incoming data stored in the program buffer may be copied to the location in the non-volatile memory device targeted by the program command, as indicated at block 1030. Embodiments in accordance with claimed subject matter may include all of, less than, or more than blocks 1010-1030. Also, the order of blocks 1010-1030 is merely an example order, and the scope of claimed subject matter is not limited in this respect.

In another example embodiment, rather than storing old data in data backup area 320 to protect the old data to be used to return memory 200 to a known state in response to a power event, new data may be stored in data backup area 320. The new data may be stored in program buffer 230 and may also be stored in data backup area 320, in an embodiment. By storing new data in data backup area 320 to be utilized in case of a power event rather than old data, the new data may be reliably retrieved from memory 200 following a power event in some situations. In an embodiment, memory 200 may comprise logic to direct read operations addressed to addressed area 252 to data backup area 320 until a background copy operation may be performed whereby new data may be copied from data backup area 320 to addressed area 252. Table 2 includes information regarding possible power-loss recovery actions that may be taken to return a memory to a known state, for one or more example embodiments. Specific actions to be taken may depend, at least in part, on at which element of a reliable write operation the power event occurs. As previously noted, power events may also occur during power-loss recover operations. Such situations may also covered by example embodiments described herein.

TABLE 2
Power-Loss Recovery for Reliable Write
(new data stored in data backup area)

| | Content of | Content of | |
|---|---|---|---|
| Element | addressed area | addressed | |
| during | 252 in memory | area 252 in | |
| which | array 250 prior | memory array | |
| power | to power-up | 250 after | |
| event | following | power-loss | Power-loss recovery |
| occurred | power-event | operations | operations performed |
| A, B, C | Old Data | Old Data | RW Flag = 0 −> no |
| | | | operation |
| D | Old Data | New Data | 1) Copy content of data |
| | | | backup area to addressed |
| | | | area of memory array; 2) |
| | | | Reset RW Flag |
| D−>E | Undetermined | New Data | 1) Copy content of data |
| | | | backup area to addressed |
| | | | area of memory array; 2) |
| | | | Reset RW Flag |
| E | New Data | New Data | 1) Copy content of data |
| | | | backup area to addressed |
| | | | area of memory array; 2) |
| | | | Reset RW Flag |
| F | New Data | New Data | RW Flag = 0 −> no |
| | | | operation |
| a, b | Undetermined | New Data | 1) Copy content of data |
| | | | backup area to addressed |
| | | | area of memory array; 2) |
| | | | Reset RW Flag |
| C | Old Data | New Data | RW Flag = 0 −> no |
| | | | operation |

Reference throughout this specification to “one embodiment” or “an embodiment” may mean that a particular feature, structure, or characteristic described in connection with a particular embodiment may be included in at least one embodiment of claimed subject matter. Thus, appearances of the phrase “in one embodiment” or “an embodiment” in various places throughout this specification are not necessarily intended to refer to the same embodiment or to any one particular embodiment described. Furthermore, it is to be understood that particular features, structures, or characteristics described may be combined in various ways in one or more embodiments. In general, of course, these and other issues may vary with the particular context of usage. Therefore, the particular context of the description or the usage of these terms may provide helpful guidance regarding inferences to be drawn for that context.

Likewise, the terms, “and,” and “or” as used herein may include a variety of meanings that also is expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe some combination of features, structures or characteristics. Though, it should be noted that this is merely an illustrative example and claimed subject matter is not limited to this example.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice-versa. The foregoing is not intended to be an exhaustive list of all examples in which a change in state for a binary one to a binary zero or vice-versa in a memory device may comprise a transformation, such as a physical transformation. Rather, the foregoing are intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

In the preceding description, various aspects of claimed subject matter have been described. For purposes of explanation, systems or configurations were set forth to provide an understanding of claimed subject matter. However, claimed subject matter may be practiced without those specific details. In other instances, well-known features were omitted or simplified so as not to obscure claimed subject matter. While certain features have been illustrated or described herein, many modifications, substitutions, changes or equivalents will now occur to those skilled in the art. It is, therefore, to be understood that the appended claims are intended to cover all such modifications or changes as fall within the true spirit of claimed subject matter.

1. A method, comprising:
storing incoming data associated with a non-volatile memory program command in a program buffer in a non-volatile memory device;
copying data previously stored at a location in the non-volatile memory device targeted by the program command to a non-volatile data backup area in the non-volatile memory; and
copying the incoming data stored in the program buffer to the location in the non-volatile memory device targeted by the program command.

2. The method of claim 1, further comprising setting a flag prior to said copying the incoming data stored in the program buffer to the location in the non-volatile memory device targeted by the program command.

3. The method of claim 2, further comprising storing an address of the location in the non-volatile memory device targeted by the program command in a non-volatile address field in a non-volatile data backup register.

4. The method of claim 2, further comprising clearing the flag at least in part in response to a completion of said copying the incoming data stored in the program buffer to the location in the non-volatile memory device targeted by the program command.

5. The method of claim 2, further comprising checking the flag at least in part in response to a non-volatile memory device power-up to determine whether a program command was in process at a time of a previous power loss.

6. The method of claim 4, further comprising copying contents of the data backup area to a location in the non-volatile memory device specified by the address stored in the address field of the data backup register at least in part in response to a determination that the flag is set, indicating that the program command was in process at the time of the previous power loss.

7. The method of claim 6, further comprising clearing the flag at least in part in response to a completion of said copying the contents of the data backup area to the location in the non-volatile memory device specified by the address stored in the address field of the data backup register.

8. A non-volatile memory device, comprising:
a program buffer to store incoming data associated with a non-volatile memory program command;
a non-volatile memory array;
a non-volatile data backup area; and
a controller to copy data previously stored at a location in the non-volatile memory array targeted by the program command to the non-volatile data backup area, the controller further to copy the incoming data stored in the program buffer to the location in the non-volatile memory array targeted by the program command.

9. The memory device of claim 8, the controller further to set a flag prior to said copying the incoming data stored in the program buffer to the location in the non-volatile memory array targeted by the program command.

10. The memory device of claim 9, further comprising a non-volatile data backup register including an address field to store an address of the location in the non-volatile memory array targeted by the program command.

11. The memory device of claim 9, the controller further to clear the flag at least in part in response to a completion of said copying the incoming data stored in the program buffer to the location in the non-volatile memory array targeted by the program command.

12. The memory device of claim 9, the controller further to check the flag at least in part in response to a power-up of the memory device to determine whether a program command was in process at a time of a previous power loss.

13. The memory device of claim 12, the controller further to copy contents of the data backup area to a location in the non-volatile memory device specified by the address stored in the address field of the data backup register at least in part in response to a determination that the flag is set, indicating that the program command was in process at the time of the previous power loss.

14. The memory device of claim 13, the controller further to clear the flag at least in part in response to a completion of said copying the contents of the data backup area to the location in the non-volatile memory device specified by the address stored in the address field of the data backup register.

15. A system, comprising:
a processor; and
a non-volatile memory device coupled to the processor, the processor to issue a program command to the memory device, the memory device comprising
a program buffer to store incoming data associated with the program command;
a non-volatile memory array;
a non-volatile data backup area; and
a controller to copy data previously stored at a location in the non-volatile memory array targeted by the program command to the non-volatile data backup area, the controller further to copy the incoming data stored in the program buffer to the location in the non-volatile memory array targeted by the program command.

16. The system of claim 15, the controller further to set a flag prior to said copying the incoming data stored in the program buffer to the location in the non-volatile memory array targeted by the program command.

17. The system of claim 16, the memory device further comprising a non-volatile data backup register including an address field to store an address of the location in the non-volatile memory array targeted by the program command.

18. The system of claim 16, the controller further to clear the flag at least in part in response to a completion of said copying the incoming data stored in the program buffer to the location in the non-volatile memory array targeted by the program command.

19. The system of claim 16, the controller further to check the flag at least in part in response to a power-up of the memory device to determine whether a program command was in process at a time of a previous power loss.

20. The system of claim 19, the controller further to copy contents of the data backup area to a location in the non-volatile memory device specified by the address stored in the address field of the data backup register at least in part in response to a determination that the flag is set, indicating that the program command was in process at the time of the previous power loss.
